(19) United States
(12) Patent Application Publication
(10) Pub. No.: US 2026/0071038 A1
(43) Pub. Date: Mar. 12, 2026

(54) FORMALDEHYDE FREE REVERSIBLE CROSSLINKERS

(71) Applicant: Synthomer Inc., Akron, OH (US)

(72) Inventors: Joel E. Goldstein, Akron, OH (US); Matthew Panzner, Akron, OH (US)

(73) Assignee: Synthomer Inc., Akron, OH (US)

(21) Appl. No.: 19/314,403

(22) Filed: Aug. 29, 2025

Related U.S. Application Data
(60) Provisional application No. 63/694,066, filed on Sep. 12, 2024.

(51) Int. Cl. C08J 7/14; C08J 3/24

(52) U.S. Cl. CPC C08J 7/14; C08J 3/24; C08J 2361/00; C08J 2401/02

(57) ABSTRACT

A method for separating a polymer-containing composition from a substrate coated with the composition is described, the method comprising contacting the coated substrate with an acidic solution under conditions sufficient to separate the composition from the substrate which can then be recycled, wherein at least one polymer present in the polymer-containing composition is formed from at least one monomer having one or more functional groups which form acid-labile (reversible) covalent crosslinking bonds with the substrate and/or with a different polymer present in the polymer-containing composition and/or with itself.

### CROSS REFERENCE TO RELATED APPLICATIONS

This application claims priority to U.S. Provisional Application No. 63/694,066, filed Sep. 12, 2024, the content of which is incorporated herein in its entirety for all purposes.

### BACKGROUND OF THE INVENTION

For several years, there has been a significant effort in preparing a formaldehyde-free crosslinking monomer to replace N-methylol acrylamide (NMA) and its methacylamide analog (NMMA). While this goal is relatively easy to accomplish, the result is typically significantly more expensive than either of the formaldehyde containing systems. In particular, NMA is made from two inexpensive raw materials (formaldehyde and acrylamide) while NMMA uses methacrylamide as an inexpensive starting material. Further, these molecules have the advantage of being small, with NMA being only 101 g/mole and NMMA being 115 g/mole. In contrast, the published formaldehyde-free alternatives start with more expensive raw materials that have a higher molecular weight with the result that so less crosslinking per pound of crosslinker is obtained.

There is also a need for economical reversible crosslinkers for use in coating compositions to allow for the separation, recovery and recycling of otherwise viable discarded substrates coated with compositions containing the reversible crosslinkers.

### SUMMARY OF THE INVENTION

An aspect of the invention is a method for separating a polymer-containing composition from a substrate coated with the composition, the method comprising: contacting the coated substrate with an acidic solution under conditions sufficient to separate the composition from the substrate, wherein at least one polymer in the polymer-containing composition is formed from at least one monomer having one or more functional groups which form acid-labile covalent crosslinking bonds with the substrate and/or with itself and/or with a different polymer present in the polymer-containing composition.

Another aspect of the invention is the use of the polymer-containing composition as described herein for forming acid-labile (i.e., reversible) covalent crosslinking bonds with a substrate, such as a fiber-containing substrate.

Another aspect of the invention is the use of a monomer of the polymer-containing composition as described herein for forming acid-labile (i.e., reversible) covalent crosslinking bonds with a substrate, such as a fiber-containing substrate.

Another aspect of the invention is a (uncoated) substrate recycled from a substrate coated with a polymer-containing composition (such as a fiber-containing substrate) as described herein by treatment of the coated substrate with an acidic solution under conditions sufficient to separate the composition from the substrate.

Another aspect of the invention is the use of a recycled substrate (such as recycled fibers) obtained by the method as described herein, such as for the purpose of preparing a coated substrate.

### BRIEF DESCRIPTION OF THE DRAWINGS

The following figures are not intended to limit the scope of the invention as described herein.

FIG. 1 shows the conventional technique of crosslinking NMA (as representative of a formaldehyde-containing monomer) with a surface of a substrate, where subsequent treatment of the crosslinked surface under acidic conditions results in no change to the surface.

FIG. 2 illustrates the invention where a monomer containing an aldehyde (R₂═H) or a ketone (R₂=an alkyl chain) covalently crosslinks with a surface of a substrate where the crosslinking bonds are acid-labile, and where subsequent treatment of the crosslinked surface under acidic conditions results in reversal of the crosslinking and regeneration of the substrate surface prior to crosslinking.

FIG. 3 illustrates the crosslinking reaction of a suitable acetal monomer (dimethoxyethylmethacrylamide) with cellulose and the subsequent reverse crosslinking reaction under acidic conditions to regenerate the uncrosslinked cellulose.

FIG. 4 illustrates a coated fabric obtained as described in the Method of Preparing Coated Fabric section.

FIG. 5 is a photograph of a fabric bound with a VA (vinyl acetate) homopolymer broken up into loose fibers after immersion in water at 50° C. for 6 hours.

FIG. 6 illustrates that after immersion in 50% acetic acid at 50° C. for >5 days, a fabric bound with a VA (vinyl acetate) and NMA (N-methylolacrylamide) copolymer does not demonstrate any observed disintegration.

FIG. 7 illustrates that after immersion in 50% acetic acid at 50° C. for 45 minutes, a fabric bound with a VA (vinyl acetate)/2.9% DAAM (diacetone acrylamide)/and 2.4% GMA (glycidyl methacrylate) terpolymer does demonstrate observed disintegration.

### DETAILED DESCRIPTION OF THE INVENTION

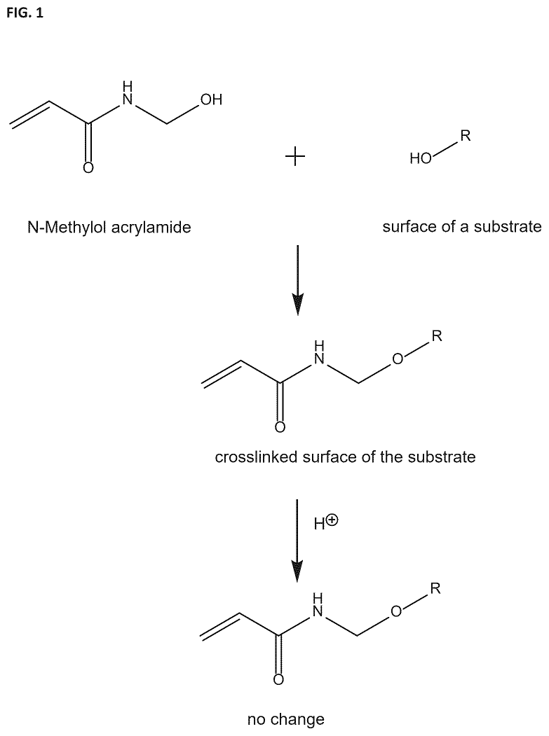

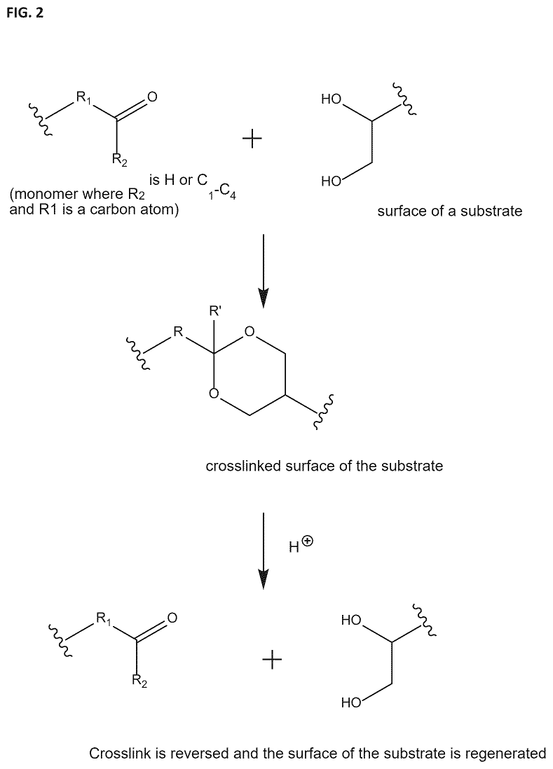

As used herein, an “acid labile covalent crosslinking bond” refers to a covalent crosslinking bond that readily cleaves (i.e., is reversible) when subjected to acidic conditions. Compare FIG. 1 which represents conventional non-reversible crosslinking to FIG. 2 which shows the reversible crosslinking associated with the invention as described herein.

As used herein, the term “(meth)acrylate” refers to both acrylate and methacrylate functionalized compounds. In various embodiments, a (meth)acrylate-functionalized compound may contain one, two, three, four, five or more (meth)acrylate functional groups per molecule.

As used herein, the term “aliphatic” refers to saturated and unsaturated hydrocarbons, straight chain (i.e., unbranched) or branched, cyclic (e.g., cycloalkyl) or acyclic, excluding aromatic groups, and includes, but is not limited to, alkyl, alkenyl and alkynyl. Illustrative aliphatic groups thus include, but are not limited to, for example, methyl, ethyl, n-propyl, isopropyl, allyl, n-butyl, sec-butyl, isobutyl, tert-butyl, n-pentyl, sec-pentyl, isopentyl, n-hexyl, sec-hexyl, alkenyl groups and alkynyl groups.

As used herein, the term “cycloalkyl” refers to saturated and unsaturated cyclic alkyls. Representative saturated cyclic alkyls include, cyclopropyl, cyclobutyl, cyclopentyl, cyclohexyl, and the like.

As used herein, the term “aryl” refers to an optionally substituted aromatic group, such as a monovalent or a bivalent aromatic group. The aryl may contain a single aromatic ring (i.e. phenyl) or more than one ring wherein at least one ring is aromatic. When the aryl comprises more than one more ring, the rings may be fused or linked via a covalent bond (for example biphenyl). Each aromatic ring may optionally comprise one to two additional fused rings (i.e. cycloalkyl, heterocycloalkyl or heteroaryl). Examples of aryls include phenyl, naphthyl, tetrahydronaphthyl, biphenyl, phenanthrenyl, naphthacenyl, fluorenyl, tetrahydrofluorenyl, indacenyl, hexahydroindacenyl, indenyl, dihydroindenyl, anthracenyl and octahydroanthracenyl. The term “(C₆-C₄₀) aryl” means an aryl having 6 to 40 carbon atoms, of which from 6 to 14 of the carbon atoms are aromatic ring carbon atoms.

As used herein, the term “halogen” refers to any fluoro, chloro, bromo, or iodo atom.

As used herein, the term “heteroaromatic” or “heteroaryl” refers to an optionally substituted aryl wherein one or more of the ring atoms are independently replaced by a heteroatom selected from O, N or S. Representative heteroaromatics include, but are not limited to, furan, benzofuran, thiophene, benzothiophene, pyrrole, indole, isoindole, 7-azaindole, 4-azaindole, 5-azaindole, 6-azaindole, 7-azaindazole, pyridine, quinoline, isoquinoline, oxazole, isoxazole, benzoxazole, pyrazole, imidazole, benzimidazole, thiazole, benzothiazole, isothiazole, 1,2,4-triazole, 1,2,3-triazole, tetrazole, 1,2,5-oxadiazole, 1,2,3-oxadiazole, 1,3,4-thiadiazole, pyridazine, pyrimidine, pyrazine, 1,2,4-triazine, 1,3,5-triazine, and the like.

As used herein, the term “substituted” refers to at least one hydrogen atom of a molecular arrangement being replaced with a substituent. The number of substituents present depends on the number of hydrogen atoms available for replacement. Substituents include, but are not limited to, halogen (e.g., F, Cl, Br, I), hydroxy (OH), oxo, cyano (CN), nitro (NO₂), amino, alkylamino, dialkylamino, branched or unbranched alkyl (e.g., methyl, ethyl, propyl, isopropyl, sec-butyl, etc.), cycloalkyl (e.g., cyclopropyl), fluoroalkyl (e.g., CF₃, CF₂H, CH₂F, CH₂CF₃.) or more generally, haloalkyl (e.g., CH₂Cl, CH(CH₃)Br, etc.), O-alkyl (alkoxy) (e.g., OCH₃, OCH₂CH₃, OCH(CH₃)₂, etc.), O-cycloalkyl (e.g., O-cyclopropyl), O-haloalkyl (e.g., OCF₂H, OCFH₂, OCF₃, OCH₂CF₃ or OCH₂Cl), O-aryl (e.g., O-phenyl), O-heteroaryl, O-heterocyclyl, thioalkyl (e.g., S—CH₃), hydroxyalkyl (e.g., CH₂OH), alkyl ether (e.g., CH₂OCH₃), alkynyl (e.g., —C≡CR_{f}), alkenyl (e.g., —CR_{f}═CR_{f}R_{g}), aryl (e.g., phenyl), arylalkyl (e.g., CH₂Ph), heteroaryl (e.g., pyridyl or any 5- or 6-membered heteroaryl ring), heteroarylalkyl (e.g., CH₂-pyridine), heterocyclyl, heterocycloalkyl and as well as, —NR_{f}R_{g}, —NR_{f}C(═O)R_{g}, —NR_{f}C(═O)NR_{f}NR_{g}, —NR_{f}—C(═O)OR_{f}SO₂R_{g}, —C(═O)R_{f}, —C(═O)OR_{f}, —OR_{f}, —C(═O)NR_{f}R_{g}, —OC(═O)NR_{f}R_{g}, —SR_{f}, —SOR_{f}, —S(═O)₂R_{f}, —OS(═O)₂R_{f} and —S(═O)OR_{f}, where each R_{f} and R_{g} may be the same or different and are independently, hydrogen, alkyl (e.g., CH₃), substituted alkyl, haloalkyl, aryl, substituted aryl, arylalkyl, substituted arylalkyl, heterocyclyl, substituted heterocyclyl, heterocycloalkyl, substituted heterocycloalkyl, heteroaryl or substituted heteroaryl.

As used herein, the term “heterocycloalkyl” or “heterocyclyl” refers to a nonaromatic ring which is either saturated or unsaturated and which contains 1 or more heteroatoms independently selected from nitrogen, oxygen and sulfur. Representative heterocycloalkyls include, but are not limited to, 2H-azirine, azetidine, 2,3-dihydroazete, 1,3-diazetidine, 2H-oxete, thietane, 2H-thiete, azetidin-2-one, morpholine, thiomorpholine, pyrrolidinone, pyrrolidinine, 2-pyrroline, 3-pyrroline, pyrazolidine, 2-pyrazoline, 2-imidazoline, imidazolidine, piperidine, piperazine, ethylene oxide (oxirane), ethylene imine (aziridine), ethylene sulfide (thiirane), oxetane, tetrahydrofuran, 1,3-dioxolane, tetrahydropyran, 1,3-dioxane and the like.

As used herein, the term “alkenyl” as used herein, refers to an unbranched or branched hydrocarbon chain having one or more carbon-carbon double bonds therein and may also be referred to as an “unsaturated alkyl”. The double bond of an alkenyl group can be unconjugated or conjugated to another unsaturated group. Suitable alkenyl groups include, but are not limited to vinyl, allyl, ethenyl, propenyl, 1-methyl-2-butene-1-yl, butenyl, pentenyl, hexenyl, butadienyl, pentadienyl, hexadienyl, 2-ethylhexenyl, 2-propyl-2-butenyl, 4-(2-methyl-3-butene)-pentenyl.

As used herein, the term “alkynyl” refers to unbranched or branched hydrocarbon chain having one or more carbon-carbon triple bonds therein and may also be referred to as an “unsaturated alkyl”. The triple bond of an alkynyl group can be unconjugated or conjugated to another unsaturated group. Suitable alkynyl groups include, but are not limited to ethynyl, 2-propynyl (propargyl), 1-propynyl, butynyl, pentynyl, hexynyl, methylpropynyl, 4-methyl-1-butynyl, and the like.

As used herein, the term “curable composition” refers to a composition that changes properties based on a stimulus. Generally, curable compositions as described herein cure through polymerization and/or crosslinking. Generally, those curable compositions cure upon the addition of energy to the system, that energy may come in the form of actinic light, heat, or both. Generally, when compounds in the curable composition contain carbon-carbon double bonds, polymerization (curing) involves reaction of such carbon-carbon double bonds.

As used herein, the term “monomer” refers to a molecule with one or more polymerizable functional groups. The monomer has a single molecular weight, typically below 1,000 g/mol, preferably 100 to 950 g/mol. As is generally recognized in the field, commercial products of a particular monomer may contain impurities or other chemical species.

As used herein, the term “oligomer” refers to molecules with a distribution of molecular weights and may or may not have one or more polymerizable functional groups. An oligomer may be the reaction product of two or more monomers and typically has a number averaged molecular weight greater than or equal to 500 g/mol, preferably 500 g/mol to 30,000 g/mol, more preferably 1,000 g/mol to 8,000 g/mol. An oligomer may not always have a single molecular weight.

As used herein, the term “number-average molecular weight” or “Mn” refers to the statistical average molecular weight of the polymer chains in a sample or grouping. Number-average molecular weights reported herein are determined using a size exclusion chromatography (SEC) using polymethyl (meth)acrylate reference standards and tetrahydrofuran as the solvent, unless expressly noted otherwise.

### Substrate

Substrates suitable for the present invention are not particularly limited and include, but are limited to, substrates comprising one or more of metal, asphalt, concrete, stone, ceramic, glass, polyester, gypsum, wood (including wood pulp), paper, paperboard, plastic and fabrics (especially nonwoven fabrics). Suitable substrate surfaces include industrial surfaces, interior surfaces, exterior surfaces, and the like.

In an exemplary embodiment, the substrate is a fiber-containing substrate.

In an exemplary embodiment, the fiber-containing substrate is a nonwoven fiber sheet or web structure bonded together by entangling fiber or filaments mechanically, thermally or chemically.

In an exemplary embodiment, one or more surfaces of the substrate is partially or completely coated with the polymer-containing composition.

In an exemplary embodiment, the substrate is polyol-containing substrate.

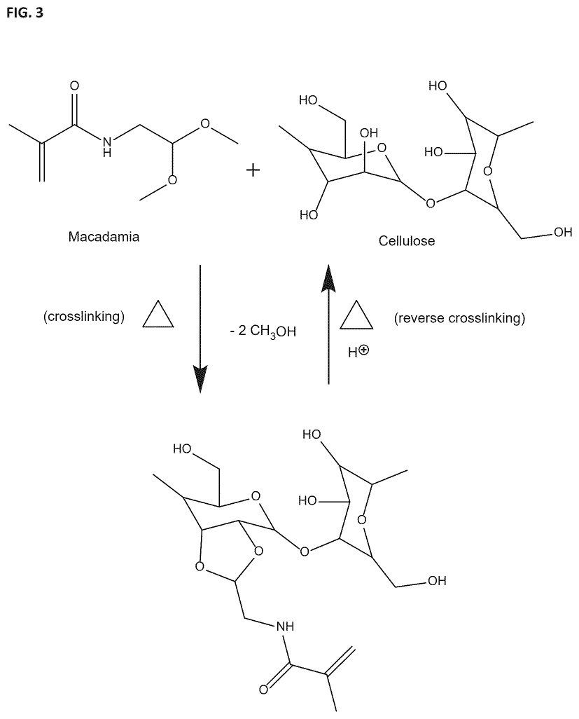

In an exemplary embodiment, the polyol-containing substrate comprises or consists of cellulose (see FIG. 3).

### Polymer-Containing Composition

In an exemplary embodiment, at least one polymer of the polymer-containing composition is covalently crosslinked with one or more surfaces of a substrate, where the covalent crosslinking bonds are acid labile.

In an exemplary embodiment, at least one polymer of the polymer-containing composition is covalently crosslinked with a different polymer also present in the composition, where the covalent crosslinking bonds are acid labile. For hydroxyl bearing substrates (e.g., cellulosics), the polymer binds to the substrate such as through the formation of an acetal structure (e.g., the dioxolane structure as described here in the Examples). For non-hydroxyl containing substrates, the monomers crosslinks with hydroxyl containing comonomers (such as 2,3-dihydroxypropyl methacrylate (hydrolyzed glycidyl methacrylate)) which has the effect of physically entrapping the substrate. The different polymer may not contain an acetal, aldehyde or ketone.

In an exemplary embodiment, at least one polymer of the polymer-containing composition is covalently crosslinked with itself, where the covalent crosslinking bonds are acid labile.

In an exemplary embodiment, at least one polymer of the polymer-containing composition is covalently crosslinked with two or more of itself, a substrate and a different polymer also present in the polymer-containing composition, where the covalent crosslinking bonds are acid labile.

In an exemplary embodiment, substantially all of the covalent crosslinking between the polymers of the polymer-containing composition and themselves is reversible (i.e., acid labile).

In an exemplary embodiment, substantially all of the covalent crosslinking between the polymers of the polymer-containing composition and different polymers also present in the polymer-containing composition is reversible (i.e., acid labile).

In an exemplary embodiment, substantially all of the covalent crosslinking between a substrate and the polymers in the polymer-containing composition that is coated on one or more surfaces of the substrate is reversible (i.e., acid labile).

In an exemplary embodiment, the reversible crosslinking involves an acetal bond.

In an exemplary embodiment, the reversible crosslinking involves a hemiacetal bond.

In an exemplary embodiment, the reversible crosslinking involves a ketal bond.

In an exemplary embodiment, the reversible crosslinking involves a hemiketal bond.

In an exemplary embodiment, the reversible crosslinking involves mixtures of two or more of acetal bonds, hemiacetal bonds, ketal bonds and hemiketal bonds.

In an exemplary embodiment, the different polymer present in the polymer-containing composition contains at least one hydroxy functional group.

In an exemplary embodiment, the different polymer contains at least a polyol functional group.

In an exemplary embodiment, the different polymer present in the polymer-containing composition includes, but is not limited to, polyvinyl acetate, acrylates (e.g., alkyl acrylates), acrylic acid, methacrylates (e.g., alkyl methacrylates), methacrylic acid, vinyl acrylates, styrene, styrene-containing copolymers (e.g., styrene butadiene, styrene acrylates, acrylonitrile butadiene styrene) and the like.

In an exemplary embodiment, at least one polymer of the polymer-containing composition contains at least one aldehyde functional group.

In an exemplary embodiment, at least one polymer of the polymer-containing composition contains at least one ketone functional group.

In an exemplary embodiment, at least one polymer of the polymer-containing composition contains at least one ketone functional group and at least one aldehyde functional group.

In an exemplary embodiment, the polymer-containing composition contains less than 0.05 wt %, such as less than 0.01 wt %, such as 0 wt %, of formaldehyde relative to the total weight of the composition.

The polymer-containing composition of the invention may comprise one or more additives that include, but are not limited to, antioxidants, ultraviolet absorbers, photostabilizers, defoamers, solvents, coalescing agents, rheology modifiers, flow or leveling agents, colorants, adhesion promoters, pigments, dispersants, wetting agents, slip additives, fillers, thixotropic agents, matting agents, waxes, neutralizers, biocides, preservatives, or other various additives, including any of the additives conventionally utilized in the paint, coating, sealant or adhesive arts.

In various embodiments, the polymer-containing composition may comprise from 0 wt % to 20 wt %, based on the total weight of the composition, of one or more of these additives, such as from 0.01 wt % to 20 wt %, such as from 0.01 wt % to 10 wt %, such as from 0.01 wt % to 5 wt %, such as from 0.01 wt % to 1 wt %, such as from 0.1 wt % to 20 wt %, such as from 0.1 wt % to 10 wt %, such as from 0.1 wt % to 5 wt %, such as from 0.1 wt % to 1 wt %, such as from 0.5 wt % to 20 wt %, such as from 0.5 wt % to 10 wt %, such as from 0.5 wt % to 5 wt %, such as from 0.5 wt % to 1 wt %.

Suitable pigments include zinc oxide, antimony oxide, zirconium oxide, chromium oxide, iron oxide, lead oxide, zinc sulfide, lithopone, and forms of titanium dioxide such as anatase and rutile.

Suitable fillers include alkaline earth metal carbonates such as calcium carbonate, clay minerals, aluminosilicates such as kaolin, andalusite, kyanite, and sillimanite, alkaline earth metal sulfate such as calcium sulfate and barium sulfate, talc, aluminum stearate, diatomaceous earth, wollastonite, nephelene syenite, alumina, silica, and silicon oxide, or combinations thereof.

Suitable wetting agents include alkoxylated surfactants, silicone surfactants, sulfosuccinates and fluorinated polymers.

Suitable ultraviolet absorbers include benzophenones (such as benzophenone and hydroxybenzophenone), benzotriazoles (such as hydroxyphenyl benzotriazole), hydroxyphenyl triazines (such as oxanilide) and thioxanthone.

The polymer-containing composition is prepared by any process which provides copolymerization of ethylenically unsaturated monomers. Suitable processes include, but are not limited to, suspension or emulsion polymerization. The polymer in particle form may also be prepared by solution polymerization techniques followed by the conversion of the solution polymer to polymer particles by conventional methods known in the art. In an embodiment, polymerization is carried out in the presence of water or an organic solvent. Various synthesis adjuvants such as initiators, chain transfer agents, and surfactants are optionally utilized in the polymerization. In a preferred embodiment, the polymer particles of the latex are prepared by aqueous emulsion polymerization techniques well known in the art (Emulsion Polymerization: Theory and Practice” by D. C. Blackley published by Wiley in 1975; Emulsion Polymerization and Emulsion Polymers by P. A. Lovell et al. published by Wiley Science in 1997; and Biomacromolecules (2020) 21(11), 4396-4441).

### Acidic Conditions

The acid used in the process described herein is not particularly limited and includes, but is not limited to, hydrochloric acid, hydrobromic acid, phosphoric acid, sulfuric acid, nitric acid, acetic acid and citric acid. In a preferred embodiment, the acid is acetic acid.

In an exemplary embodiment, the acidic solution comprises water, optionally in the presence of one or more organic solvents, such as an alcohol (e.g., methanol, ethanol, propanol and the like).

In an exemplary embodiment, the acidic solution has a pH of greater than 1, such as greater than 2, such as greater than 3, such as greater than 4, and less than 7, such as less than 6, such as less than less than 5, such as less than 4.

In an exemplary embodiment, the acidic solution is an aqueous acetic acid solution.

In an exemplary embodiment, the coated substrate is completely submerged in an acidic solution or sprayed with an acidic solution.

In an exemplary embodiment, the acidic solution in contact with the coated substrate is agitated during separation of the polymer-containing composition from the substrate.

In an exemplary embodiment, the acidic solution in contact with the coated substrate is agitated and heated during separation of the polymer-containing composition from the substrate.

In an exemplary embodiment, the polymer-containing composition is at least partially separated from the substrate after contact with the acidic solution.

In an exemplary embodiment, the polymer-containing composition is substantially separated from the substrate after contact with the acidic solution.

In an exemplary embodiment, the polymer-containing composition is completely separated from the substrate after contact with the acidic solution.

In an exemplary embodiment, the coated substrate is contacted with an acidic solution at a temperature of 40° C. to 75° C. (such as 40° C. to 65° C., such as 45° C. to 65° C., such as 50° C. to 75° C., such as 50° C. to 65° C.) for a period of 3 minutes to 2 days (such as 10 minutes to 2 days, such as 30 minutes to 2 days, such as 60 minutes to 2 days, such as 3 hours to 2 days, such as 12 hours to 2 days, such as 24 hours to 2 days, such as 10 minutes to 24 hours, such as 30 minutes to 24 hours, such as 60 minutes to 24 hours, such as 3 hours to 24 hours, such as 12 hours to 24 hours).

### Monomers

In an exemplary embodiment, at least one polymer in the polymer-containing composition is formed from at least one monomer having the structure of Formula (1):

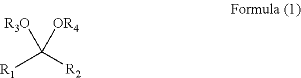

wherein R₁ is or contains an ethylenically unsaturated group, including, but not limited to, an acrylate group, a methacrylate group, a styrene group, a butadiene group, an ethylene group, a vinyl group, an acrylamide group or a halide; R₂ is not particularly limited and may be H, aliphatic (such as C₁-C₆ alkyl, cycloalkyl, alkenyl or alkynyl), aryl, heteroaryl or heterocyclyl, where the aliphatic, aryl, heteroraryl and heterocyclyl moieties are unsubstituted or substituted; R₃ is H, aliphatic (such as C₁-C₄ alkyl or cycloalkyl), aryl, heteroaryl or heterocyclyl, where the aliphatic, aryl, heteroraryl and heterocyclyl moieties are unsubstituted or substituted; and R₄ is H, aliphatic (such as C₁-C₄ alkyl or cycloalkyl), aryl, heteroaryl or heterocyclyl, where the aliphatic, aryl, heteroraryl and heterocyclyl moieties are unsubstituted or substituted; or R₃O and R₄O together with the carbon atom attached to R₃O and R₄O form a carbonyl (C═O) group. In a preferred embodiment, one or both of R₃ and R₄ is C₁-C₄ alkyl.

In an exemplary embodiment of Formula (1), R₁ is or contains an acrylate group, a methacrylate group, a styrene group, a butadiene group, an ethylene group, a vinyl group, an acrylamide group or a halide; and R₂ is H.

In an exemplary embodiment of Formula (1), R₁ is or contains an acrylate group, a methacrylate group, a styrene group, a butadiene group, an ethylene group, a vinyl group, an acrylamide group or a halide; and R₂ is C₁-C₄ alkyl.

In an exemplary embodiment of Formula (1), R₁ is or contains an acrylate group, a methacrylate group, a styrene group, a butadiene group, an ethylene group, a vinyl group, an acrylamide group or a halide; R₂ is H; and R₃ or R₄ is H or C₁-C₄ alkyl.

In an exemplary embodiment of Formula (1), R₁ is or contains an acrylate group, a methacrylate group, a styrene group, a butadiene group, an ethylene group, a vinyl group, an acrylamide group or a halide; R₂ is C₁-C₄ alkyl; and R₃ or R₄ is H or C₁-C₄ alkyl.

In an exemplary embodiment of Formula (1), R₁ is or contains an acrylate group, a methacrylate group, a styrene group, a butadiene group, an ethylene group, a vinyl group, an acrylamide group or a halide; R₂ is H; and neither R₃ nor R₄ is H.

In an exemplary embodiment of Formula (1), R₁ is or contains an acrylate group, a methacrylate group, a styrene group, a butadiene group, an ethylene group, a vinyl group, an acrylamide group or a halide; and R₂ is C₁-C₄ alkyl; and neither R₃ nor R₄ is H.

In an exemplary embodiment of Formula (1), R₁ is or contains an acrylate group, a methacrylate group, a styrene group, a butadiene group, an ethylene group, a vinyl group, an acrylamide group or a halide; R₂ is H; and both R₃ and R₄ are H.

In an exemplary embodiment of Formula (1), R₁ is or contains an acrylate group, a methacrylate group, a styrene group, a butadiene group, an ethylene group, a vinyl group, an acrylamide group or a halide; and R₂ is C₁-C₄ alkyl; and both R₃ and R₄ are H.

In an exemplary embodiment of Formula (1), R₁ is or contains an acrylate group, a methacrylate group, a styrene group, a butadiene group, an ethylene group, a vinyl group, an acrylamide group or a halide; R₂ is H; and both R₃ and R₄ are C₁-C₄ alkyl.

In an exemplary embodiment of Formula (1), R₁ is or contains an acrylate group, a methacrylate group, a styrene group, a butadiene group, an ethylene group, a vinyl group, an acrylamide group or a halide; and R₂ is C₁-C₄ alkyl; and both R₃ and R₄ are C₁-C₄ alkyl.

In an exemplary embodiment of Formula (1), R₁ is or contains an acrylate group, a methacrylate group, a styrene group, a butadiene group, an ethylene group, a vinyl group, an acrylamide group or a halide; R₂ is H; and R₃O and R₄O together with the carbon atom attached to R₃O and R₄O form a carbonyl (C═O).

In an exemplary embodiment of Formula (1), R₁ is or contains an acrylate group, a methacrylate group, a styrene group, a butadiene group, an ethylene group, a vinyl group, an acrylamide group or a halide; and R₂ is C₁-C₄ alkyl; and R₃O and R₄O together with the carbon atom attached to R₃O and R₄O form a carbonyl (C═O).

In an exemplary embodiment, the monomers of Formula (1) are present in the polymer-containing composition in an amount of −1-40 wt %, such as 1-35 wt %, such as 1-30 wt %, such as 1-25%, such as 1-20%, such as 1-15%, such as 5-35 wt %, such as 5-30 wt %, such as 5-25%, such as 5-20%, such as 5-15%, where the wt % is relative to the total wt % of the polymer-containing composition.

Other suitable monomers are known in the conventional art as evidenced by U.S. Publication No. 2013/0245204, U.S. Pat. Nos. 5,463,007; 5,369,185; 4,663,410; ACS Symp. Ser. (1988) 367, 453-466; Symp. Ser. (1988) 367, 467-478; and Polymer Science Series B (2011) 53, 278-282.

Other monomers present in the polymer-containing composition prior to polymerization (i.e., curing) are not particularly limited and may include one, two, three, or four or more ethylenically unsaturated compounds containing at least one carbon-carbon double bond alpha to an ester group (i.e., at least one α,β-unsaturated ester moiety), in particular a carbon-carbon double bond capable of participating in a free radical reaction or anionic reaction, such as a reaction initiated by persulfates, peroxides, azo-containing compounds or other conventional radical initiators.

These other ethylenically unsaturated monomers include, but are not limited to, vinyl acetate, butadiene, styrene, (meth)acrylamide and/or derivatives thereof (e.g., hydroxymethyl)acrylamide, N-(hydroxyethyl) acrylamide, 2-hydroxypropyl methacrylamide, methacrylamide poly(ethylene glycol) amine hydrochloride, N-tris(hydroxymethyl)methylacrylamide, (4-hydroxyphenyl)methacrylamide, 2-aminoethylmethacrylamide hydrochloride, and N-phenylacrylamide), various C₁-C₃₀alkyl esters of (meth)acrylic acid (e.g., methyl (meth)acrylate, ethyl (meth)acrylate, n-butyl (meth)acrylate, 2-ethylhexyl (meth)acrylate, cyclohexyl (meth)acrylate, n-octyl (meth)acrylate, n-decyl (meth)acrylate, n-dodecyl (meth)acrylate, tetradecyl (meth)acrylate, lauryl (meth)acrylate, oleyl (meth)acrylate, palmityl (meth)acrylate, and stearyl (meth)acrylate), isobornyl (meth)acrylate, benzyl (meth)acrylate, phenyl (meth)acrylate, 2-phenylethyl (meth)acrylate, 1-naphthyl (meth)acrylate, ethoxyethyl (meth)acrylate, ethyl maleate, dimethyl fumarate, ethyl methyl itaconate, (meth)acrylic acid, itaconic acid, fumaric acid, maleic acid, styrene, α-methyl styrene, vinyl ethers, vinyl esters, vinyl pyridine, vinyl toluene, divinyl toluene, vinyl naphthalene, caprolactone (meth)acrylate, diethylene glycol methyl ether (meth)acrylate, diethylene glycol ethyl ether (meth)acrylate, diethylene glycol butyl ether (meth)acrylate, triethylene glycol methyl ether (meth)acrylate, polyethylene glycol (meth)acrylate, poly(propylene glycol) (meth)acrylate, crosslinker monomers include but not limited to divinyl naphthalene, allyl (meth)acrylate, tripropylene glycol di(meth)acrylate, diethylene glycol di(meth)acrylate, ethylene glycol di(meth)acrylate, 1,6-hexanediol di(meth)acrylate, 1,2-butylene glycol di(meth)acrylate, 1,3-butylene glycol di(meth)acrylate, 1,4-butylene glycol di(meth)acrylate, neopentyl glycol di(meth)acrylate, dodecyl di(meth)acrylate, cyclohexane dimethanol di(meth)acrylate, dipropylene glycol di(meth)acrylate, tricyclodecane dimethanol diacrylate, triethylene glycol di(meth)acrylate, tetraethylene glycol di(meth)acrylate, tripropylene glycol di(meth)acrylate, diallyl phthalate, trimethylolpropane tri(meth)acrylate, triethylolpropane tri(meth)acrylate, pentaerythritol tetra(meth)acrylate, dipentaerythritol penta(meth)acrylate, and combinations thereof.

Other suitable monomers include acrylonitrile, vinyl cyanide, vinylpyrrolidone, polypropylene glycol mono(meth)acrylate, polyethylene glycol mono(meth)acrylate, sulfur-based monomers (e.g., vinyl- and allyl-sulfonic and sulfuric acids, sulfoethyl (meth)acrylate, aryl-sulfonic and sulfuric acids, (meth)acrylamidoethane-sulfonic and sulfuric acids, methacrylamido-2-methyl propanesulfonic and sulfuric acids, and salts (e.g., alkali metal or ammonium salts) of these sulfonic and sulfuric acids), hydroxyl functionalized co-monomers (e.g., 2-hydroxyethyl acrylate, 2-hydroxyethyl methacrylate, 2-hydroxypropyl acrylate, 2-hydroxypropyl methacrylate, 2,3-dihydroxypropyl methacrylate (hydrolyzed glycidyl methacrylate)), silane co-monomers (e.g., methacryloxypropyl trimethoxysilane, methacryloxypropyl triethoxysilane, methacryloxypropyl tripropoxysilane, vinyltriacetoxysilane, vinyltrimethoxysilane, vinyltriethoxysilane), crosslinkable co-monomers capable of reacting with a separate crosslinking agent (e.g., acetoacetate co-monomers containing (meth)acrylate, allyl or vinyl functional groups including, but not limited to, acetoacetate moieties such as: 2-acetoacetoxyethyl (meth)acrylate, 3-acetoacetoxypropyl (meth)acrylate, 4-acetoacetoxybutyl (meth)acrylate, 2-cyanoacetoxyethyl (meth)acrylate, 3-cyanoacetoxypropyl (meth)acrylate, 4-cyanoacetoxybutyl (meth)acrylate, N-(2-acetoacetoxyethyl) (meth)acrylamide, allyl acetoacetate, 2,3-di(acetoacetoxy)propyl (meth)acrylate, vinyl acetoacetate and combinations thereof.

The relative proportions of, for example, the above listed ethylenically unsaturated compounds utilized to form the polymer-containing composition of the invention may be varied as appropriate depending upon the particular components selected and the properties of the coating composition obtained therefrom which are desired.

Oligomers may be present in the polymer-containing compositions. Suitable oligomers include (meth)acrylate-functionalized oligomers which include, for example, polyester (meth)acrylates, polyether (meth)acrylates, epoxy (meth)acrylates, urethane (meth)acrylates (also referred to as polyurethane (meth)acrylates or urethane (meth)acrylate oligomers) and combinations thereof, as well as amine-modified and sulfide-modified variations thereof.

Examples of suitable epoxy (meth)acrylate oligomers include the reaction products of acrylic or methacrylic acid or mixtures thereof with glycidyl ethers or esters. For example, the glycidyl ether may be a polyglycidyl ether of a bisphenol such as bisphenol A or oligomer thereof.

Suitable polyether (meth)acrylate oligomers include, but are not limited to, the condensation reaction products of acrylic or methacrylic acid or mixtures thereof with polyetherols which are polyether polyols (such as polyethylene glycol, polypropylene glycol or polytetramethylene glycol). Suitable polyetherols can be linear or branched compounds containing ether bonds and terminal hydroxyl groups. Polyetherols can be prepared by ring opening polymerization of cyclic ethers such as tetrahydrofuran or alkylene oxides with a starter molecule. Suitable starter molecules include, but are not limited to, water, polyhydroxyl functional compounds, polyester polyols and amines.

Suitable polyurethane (meth)acrylate oligomers may be prepared by reacting aliphatic and/or aromatic diisocyanates with OH-group terminated polyester polyols (including aromatic, aliphatic and mixed aliphatic/aromatic polyester polyols), polyether polyols, polycarbonate polyols, polycaprolactone polyols, polyorganosiloxane polyols (e.g., polydimethylsiloxane polyols), or polydiene polyols (e.g., polybutadiene polyols), or combinations thereof to form isocyanate-functionalized oligomers which are then reacted with hydroxyl-functionalized (meth)acrylates such as hydroxyethyl acrylate or hydroxyethyl methacrylate to provide terminal (meth)acrylate groups. For example, the polyurethane (meth)acrylate oligomers may contain two, three, four or more (meth)acrylate functional groups per molecule.

### Utility

The polymer-containing composition of the invention as described and the monomer(s) from which the polymer is formed find use in technical applications where recycling of a substrate on which the polymer-containing composition is coated is desirable for economic and environmental reasons. Such industries include paper, construction, and non-woven fabric manufacturing.

### EXAMPLES

### Synthesis of 2,2-dimethoxyethyl Methacrylamide (Macadamia)

To a 2 L jacketed reactor was added 207.0 g (1.97 mol) of aminoacetaldehyde dimethyl acetal in 800 g of distilled water at 18° C. Then 315.4 g (2.05 mol) of methacrylic anhydride was added over 60 minutes (reaction temperature maintained below 30° C. and the pH above 4). Then 800 ml of methylene chloride and 100 g of dilute aqueous hydrochloric acid (18%) were added and the layers separated. The organic layer was washed several times with aqueous sodium bicarbonate until the pH is neutral. The layers were then separated. The solvent was then removed by using a rotary evaporator.

### Synthesis of Formyl Phenyl Acrylate (FPA)

To a 2 L jacketed reactor was added 1000 ml of methylene chloride Then 244 g of 4-hydroxybenzaldehyde and 202.0 g of triethylamine were added. The solution was cooled to 10° C. by the water bath circulating water through the jacket of the reactor. Then 0.5 g of butylated hydroxytoluene (BHT) was added. Then 180 g (2.0 mol) of acryloyl chloride was added over three hours while the temperature is maintained below 30° C. (86° F.). After 60 minutes, the water bath was set to room temperature (22° C., 71° F.) and the contents of the reactor were allowed to stir overnight at this temperature. The mixture was washed with 200 g of aqueous dilute hydrochloric acid (18%). The layers were separated. The organic layer was washed several times with aqueous sodium bicarbonate until the pH was neutral. The layers were then separated. The solvent was then removed by using a rotary evaporator.

### Synthesis of Formyl Phenyl Methacrylate (FPMA)

To a 2 L jacketed reactor was added 61.2 g (0.5 mol) of 4-hydroxybenzaldehyde in 600 g of methylene chloride. Then 0.7 g of BHT and 0.2 g of 4-(dimethylamino)pyridine were added. The temperature was raised to that of refluxing methylene chloride (39° C. (103.3° F.)) by the water bath circulating water through the jacket of the reactor. To this hot reactor, 77 g (0.51 mol) of methacrylic anhydride was added over 60 minutes. Thirty minutes after the methacrylic anhydride had been added, the reactor was allowed to cool to room temperature (22° C., 71° F.). The contents of the reactor were allowed to stir for 15 minutes. The mixture was washed with 200 g of aqueous dilute hydrochloric acid (18%). The contents of the reactor were allowed to stir for 15 minutes then the layers were separated. The organic layer was washed several times with aqueous sodium bicarbonate until the pH was neutral. The layers were then separated. The solvent was then removed by using a rotary evaporator.

### Preparation of Vinyl Acetate-Based Polymers Containing N-Methylolacrylamide

A 2 L jacketed reactor was charged with 2.0 g of non-ionic surfactant T-DET® 09 (Harcros Chemicals), 1.58 g of non-ionic surfactant T-DET® N 307 (Harcros Chemicals), 8.58 g of hydroxyethylcellulose rheology modifier NATROSOL™ 250-LR (Ashland), 0.95 g of ferrous sulfate and 448.72 g of distilled water. This solution was heated to 67° C. (153° F.) and 49.67 g of vinyl acetate was added. An initiator solution of 1.35 g of potassium persulfate in 43.9 g of distilled water was added to the reactor. A pre-emulsion of 2.27 g of non-ionic surfactant T-DET® 09 (Harcros Chemicals), 5.32 g of non-ionic surfactant T-DET® N 307 (Harcros Chemicals), disodium oleamido MIPA-sulfosuccinate surfactant Pureact MD-318 (Innospec Performance Chemicals), 638.12 g of vinyl acetate, 44.7 g of 50% aqueous N-methylolacrylamide in 161.5 g of distilled water was prepared as was an oxidizer feed of 1.35 g of potassium persulfate and 0.71 g of 28% aqueous ammonium hydroxide in 80.9 g of distilled water. These two solutions were added to the reactor over four hours and maintained at 79° C. (174° F.) once that temperature was achieved by the exotherm. After the addition, the batch was cooled to 70° C. (158° F.). A solution of 0.25 g of potassium persulfate and 0.62 g of 70% aqueous tert-butyl hydroperoxide in 9.22 g of distilled water was prepared. A solution of 0.31 g of sodium formaldehyde sulfoxylate in 7.05 g of distilled water was also prepared. These two solutions were added at 70° C. (158° F.) and the reactor was held there for 30 minutes. The reactor was then cooled to 40° C. (104° F.) and 0.43 g of 28% aqueous ammonium hydroxide, 0.06 g of Biocide (water borne formulation of benzisothiazolinone (BIT)/methylisothiazolinone (MIT)) and 10.64 g of distilled water were added. The contents of the reactor were stirred for 15 minutes and then stored in a jar.

Preparation of Vinyl Acetate Polymer without any Crosslinker

A 2 L jacketed reactor was charged with 2.0 g of non-ionic surfactant T-DET® 09 (Harcros Chemicals), 1.58 g of non-ionic surfactant T-DET® N 307 (Harcros Chemicals), 8.58 g of hydroxyethylcellulose rheology modifier NATROSOL™ 250-LR (Ashland), 0.95 g of ferrous sulfate and 448.72 g of distilled water. This solution was heated to 67° C. (153° F.) and 49.67 g of vinyl acetate was added. An initiator solution of 1.35 g of potassium persulfate in 43.9 g of distilled water was added to the reactor. A pre-emulsion of 2.27 g of non-ionic surfactant T-DET® 09 (Harcros Chemicals), 5.32 g of non-ionic surfactant T-DET® N 307 (Harcros Chemicals), disodium oleamido MIPA-sulfosuccinate surfactant Pureact MD-318 (Innospec Performance Chemicals), 638.12 g of vinyl acetate in 161.5 g of distilled water was prepared as was an oxidizer feed of 1.35 g of potassium persulfate and 0.71 g of 28% aqueous ammonium hydroxide in 80.9 g of distilled water. These two solutions were added to the reactor over four hours and maintained at 79° C. (174° F.) once that temperature was achieved by the exotherm. After the addition, the batch was cooled to 70° C. (158° F.). A solution of 0.25 g of potassium persulfate and 0.62 g of 70% aqueous tert-butyl hydroperoxide in 9.22 g of distilled water was prepared. A solution of 0.31 g of sodium formaldehyde sulfoxylate in 7.05 g of distilled water was also prepared. These two solutions were added at 70° C. (158° F.) and the reactor was held there for 30 minutes. The reactor was then cooled to 40° C. (104° F.) and 0.43 g of 28% aqueous ammonium hydroxide, 0.06 g of Biocide (water borne formulation of benzisothiazolinone (BIT)/methylisothiazolinone (MIT)) and 10.64 g of distilled water were added. The contents of the reactor were stirred for 15 minutes and then stored in a jar.

Preparation of Vinyl Acetate-Based Polymer Containing 2,2-dimethoxyethyl Methacrylamide

A 2 L jacketed reactor was charged with 2.0 g of non-ionic surfactant T-DET® 09 (Harcros Chemicals), 1.58 g of non-ionic surfactant T-DET® N 307 (Harcros Chemicals), 8.58 g of hydroxyethylcellulose rheology modifier NATROSOL™ 250-LR (Ashland), 0.95 g of ferrous sulfate and 448.72 g of distilled water. This solution was heated to 67° C. (153° F.) and 49.67 g of vinyl acetate was added. An initiator solution of 1.35 g of potassium persulfate in 43.9 g of distilled water was added to the reactor. A pre-emulsion of 2.27 g of non-ionic surfactant T-DET® 09 (Harcros Chemicals), 5.32 g of non-ionic surfactant T-DET® N 307 (Harcros Chemicals) disodium oleamido MIPA-sulfosuccinate surfactant Pureact MD-318 (Innospec Performance Chemicals), 638.12 g of vinyl acetate, 21.8 g of 2,2-dimethoxyethyl methacrylamide in 161.5 g of distilled water was prepared as was an oxidizer feed of 1.35 g of potassium persulfate and 0.71 g of 28% aqueous ammonium hydroxide in 80.9 g of distilled water. These two solutions were added to the reactor over four hours and maintained at 79° C. (174° F.) once that temperature was achieved by the exotherm. After the addition, the batch was cooled to 70° C. (158° F.). A solution of 0.25 g of potassium persulfate and 0.62 g of 70% aqueous tert-butyl hydroperoxide in 9.22 g of distilled water was prepared. A solution of 0.31 g of sodium formaldehyde sulfoxylate in 7.05 g of distilled water was also prepared. These two solutions were added at 70° C. (158° F.) and the reactor was held there for 30 minutes. The reactor was then cooled to 40° C. (104° F.) and 0.43 g of 28% aqueous ammonium hydroxide, 0.06 g of Biocide (water borne formulation of benzisothiazolinone (BIT)/methylisothiazolinone (MIT)) and 10.64 g of distilled water were added. The contents of the reactor were stirred for 15 minutes and then stored in a jar.

### Preparation of Vinyl Acetate-Based Polymer Containing Diacetone Acrylamide Plus Glycidyl Methacrylate (GMA)

A 2 L jacketed reactor was charged with 2.0 g of non-ionic surfactant T-DET® 09 (Harcros Chemicals), 1.58 g of non-ionic surfactant T-DET® N 307 (Harcros Chemicals), 8.58 g of hydroxyethylcellulose rheology modifier NATROSOL™ 250-LR (Ashland), 0.95 g of ferrous sulfate and 448.72 g of distilled water. This solution was heated to 67° C. (153° F.) and 49.67 g of vinyl acetate was added. An initiator solution of 1.35 g of potassium persulfate in 43.9 g of distilled water was added to the reactor. A pre-emulsion of 2.27 g of non-ionic surfactant T-DET® 09 (Harcros Chemicals), 5.32 g of non-ionic surfactant T-DET® N 307 (Harcros Chemicals), disodium oleamido MIPA-sulfosuccinate surfactant Pureact MD-318 (Innospec Performance Chemicals), 638.12 g of vinyl acetate, 21.7 g of diacetone acrylamide (DAAM), 18.2 g of glycidyl methacrylate (GMA) in 161.5 g of distilled water was prepared as was an oxidizer feed of 1.35 g of potassium persulfate and 0.71 g of 28% aqueous ammonium hydroxide in 80.9 g of distilled water. These two solutions were added to the reactor over four hours and maintained at 79° C. (174° F.) once that temperature was achieved by the exotherm. After the addition, the batch was cooled to 70° C. (158° F.). A solution of 0.25 g of potassium persulfate and 0.62 g of 70% aqueous tert-butyl hydroperoxide in 9.22 g of distilled water was prepared. A solution of 0.31 g of sodium formaldehyde sulfoxylate in 7.05 g of distilled water was also prepared. These two solutions were added at 70° C. (158° F.) and the reactor was held there for 30 minutes. The reactor was then cooled to 40° C. (104° F.) and 0.43 g of 28% aqueous ammonium hydroxide, 0.06 g of Biocide (water borne formulation of benzisothiazolinone (BIT)/methylisothiazolinone (MIT)) and 10.64 g of distilled water were added. The contents of the reactor were stirred for 15 minutes and then stored in a jar.

### Preparation of Vinyl Acetate-Based Polymer Containing Acetocetoxyethyl Methacrylate (AAEM) Plus Glycidyl Methacrylate (GMA)

A 2 L jacketed reactor was charged with 2.0 g of non-ionic surfactant T-DET® 09 (Harcros Chemicals), 1.58 g of non-ionic surfactant T-DET® N 307 (Harcros Chemicals), 8.58 g of hydroxyethylcellulose rheology modifier NATROSOL™ 250-LR (Ashland), 0.95 g of ferrous sulfate and 448.72 g of distilled water. This solution was heated to 67° C. (153° F.) and 49.67 g of vinyl acetate was added. An initiator solution of 1.35 g of potassium persulfate in 43.9 g of distilled water was added to the reactor. A pre-emulsion of 2.27 g of non-ionic surfactant T-DET® 09 (Harcros Chemicals), 5.32 g of non-ionic surfactant T-DET® N 307 (Harcros Chemicals), disodium oleamido MIPA-sulfosuccinate surfactant Pureact MD-318 (Innospec Performance Chemicals), 638.12 g of vinyl acetate, 21.7 g acetocetoxyethyl methacrylate (AAEM), 18.2 g of glycidyl methacrylate (GMA) in 161.5 g of distilled water was prepared as was an oxidizer feed of 1.35 g of potassium persulfate and 0.71 g of 28% aqueous ammonium hydroxide in 80.9 g of distilled water. These two solutions were added to the reactor over four hours and maintained at 79° C. (174° F.) once that temperature was achieved by the exotherm. After the addition, the batch was cooled to 70° C. (158° F.). A solution of 0.25 g of potassium persulfate and 0.62 g of 70% aqueous tert-butyl hydroperoxide in 9.22 g of distilled water was prepared. A solution of 0.31 g of sodium formaldehyde sulfoxylate in 7.05 g of distilled water was also prepared. These two solutions were added at 70° C. (158° F.) and the reactor was held there for 30 minutes. The reactor was then cooled to 40° C. (104° F.) and 0.43 g of 28% aqueous ammonium hydroxide, 0.06 g of Biocide (water borne formulation of benzisothiazolinone (BIT)/methylisothiazolinone (MIT)) and 10.64 g of distilled water were added. The contents of the reactor were stirred for 15 minutes and then stored in a jar.

Preparation of the Vinyl Acrylic Polymer with N-Methylolacrylamide

A 2 L jacketed reactor was charged with 2.0 g of non-ionic surfactant T-DET® 09 (Harcros Chemicals), 1.58 g of non-ionic surfactant T-DET® N 307 (Harcros Chemicals), 8.58 g of hydroxyethylcellulose rheology modifier NATROSOL™ 250-LR (Ashland), 0.95 g of ferrous sulfate and 448.72 g of distilled water. This solution was heated to 67° C. (153° F.) and 49.67 g of vinyl acetate was added. An initiator solution of 1.35 g of potassium persulfate in 43.9 g of distilled water was added to the reactor. A pre-emulsion of 2.27 g of non-ionic surfactant T-DET® 09 (Harcros Chemicals), 5.32 g of non-ionic surfactant T-DET® N 307 (Harcros Chemicals), disodium oleamido MIPA-sulfosuccinate surfactant Pureact MD-318 (Innospec Performance Chemicals), 542.4 g of vinyl acetate, 95.7 g of butyl acrylate, 44.7 g of 50% aqueous N-methylolacrylamide in 161.5 g of distilled water was prepared as was an oxidizer feed of 1.35 g of potassium persulfate and 0.71 g of 28% aqueous ammonium hydroxide in 80.9 g of distilled water. These two solutions were added to the reactor over four hours and maintained at 79° C. (174° F.) once that temperature was achieved by the exotherm. After the addition, the batch was cooled to 70° C. (158° F.). A solution of 0.25 g of potassium persulfate and 0.62 g of 70% aqueous tert-butyl hydroperoxide in 9.22 g of distilled water was prepared. A solution of 0.31 g of sodium formaldehyde sulfoxylate in 7.05 g of distilled water was also prepared. These two solutions were added at 70° C. (158° F.) and the reactor was held there for 30 minutes. The reactor was then cooled to 40° C. (104° F.) and 0.43 g of 28% aqueous ammonium hydroxide, 0.06 g of Biocide (water borne formulation of benzisothiazolinone (BIT)/methylisothiazolinone (MIT)) and 10.64 g of distilled water were added. The contents of the reactor were stirred for 15 minutes and then stored in a jar.

Preparation of the Vinyl Acrylic Polymer without any Crosslinker

A 2 L jacketed reactor was charged with 2.0 g of non-ionic surfactant T-DET® 09 (Harcros Chemicals), 1.58 g of non-ionic surfactant T-DET® N 307 (Harcros Chemicals), 8.58 g of hydroxyethylcellulose rheology modifier NATROSOL™ 250-LR (Ashland), 0.95 g of ferrous sulfate and 448.72 g of distilled water. This solution was heated to 67° C. (153° F.) and 49.67 g of vinyl acetate was added. An initiator solution of 1.35 g of potassium persulfate in 43.9 g of distilled water was added to the reactor. A pre-emulsion of 2.27 g of non-ionic surfactant T-DET® 09 (Harcros Chemicals), 5.32 g of non-ionic surfactant T-DET® N 307 (Harcros Chemicals), disodium oleamido MIPA-sulfosuccinate surfactant Pureact MD-318 (Innospec Performance Chemicals), 542.4 g of vinyl acetate, 95.7 g of butyl acrylate in 161.5 g of distilled water was prepared as was an oxidizer feed of 1.35 g of potassium persulfate and 0.71 g of 28% aqueous ammonium hydroxide in 80.9 g of distilled water. These two solutions were added to the reactor over four hours and maintained at 79° C. (174° F.) once that temperature was achieved by the exotherm. After the addition, the batch was cooled to 70° C. (158° F.). A solution of 0.25 g of potassium persulfate and 0.62 g of 70% aqueous tert-butyl hydroperoxide in 9.22 g of distilled water was prepared. A solution of 0.31 g of sodium formaldehyde sulfoxylate in 7.05 g of distilled water was also prepared. These two solutions were added at 70° C. (158° F.) and the reactor was held there for 30 minutes. The reactor was then cooled to 40° C. (104° F.) and 0.43 g of 28% aqueous ammonium hydroxide, 0.06 g of Biocide (water borne formulation of benzisothiazolinone (BIT)/methylisothiazolinone (MIT)) and 10.64 g of distilled water were added. The contents of the reactor were stirred for 15 minutes and then stored in a jar.

Preparation of the Vinyl Acrylic Polymer with Acetocetoxyethyl Methacrylate (AAEM)

A 2 L jacketed reactor was charged with 2.0 g of non-ionic surfactant T-DET® 09 (Harcros Chemicals), 1.58 g of non-ionic surfactant T-DET® N 307 (Harcros Chemicals), 8.58 g of hydroxyethylcellulose rheology modifier NATROSOL™ 250-LR (Ashland), 0.95 g of ferrous sulfate and 448.72 g of distilled water. This solution was heated to 67° C. (153° F.) and 49.67 g of vinyl acetate was added. An initiator solution of 1.35 g of potassium persulfate in 43.9 g of distilled water was added to the reactor. A pre-emulsion of 2.27 g of non-ionic surfactant T-DET® 09 (Harcros Chemicals), 5.32 g of non-ionic surfactant T-DET® N 307 (Harcros Chemicals), disodium oleamido MIPA-sulfosuccinate surfactant Pureact MD-318 (Innospec Performance Chemicals), 542.4 g of vinyl acetate, 95.7 g of butyl acrylate, 21.7 g of acetocetoxyethyl methacrylate (AAEM) in 161.5 g of distilled water was prepared as was an oxidizer feed of 1.35 g of potassium persulfate and 0.71 g of 28% aqueous ammonium hydroxide in 80.9 g of distilled water. These two solutions were added to the reactor over four hours and maintained at 79° C. (174° F.) once that temperature was achieved by the exotherm. After the addition, the batch was cooled to 70° C. (158° F.). A solution of 0.25 g of potassium persulfate and 0.62 g of 70% aqueous tert-butyl hydroperoxide in 9.22 g of distilled water was prepared. A solution of 0.31 g of sodium formaldehyde sulfoxylate in 7.05 g of distilled water was also prepared. These two solutions were added at 70° C. (158° F.) and the reactor was held there for 30 minutes. The reactor was then cooled to 40° C. (104° F.) and 0.43 g of 28% aqueous ammonium hydroxide, 0.06 g of Biocide (water borne formulation of benzisothiazolinone (BIT)/methylisothiazolinone (MIT)) and 10.64 g of distilled water were added. The contents of the reactor were stirred for 15 minutes and then stored in a jar.

Preparation of the Pure Acrylic Polymer with N-Methylolmethacrylamide

A 3 L jacketed reactor was charged with 340.2 g of distilled water and 1.58 g of lauryl alcohol sulfate emulsifier DISPONIL® SLS 2010 (BASF). To this was added 3.51 g of distilled water and 0.16 g of ammonium persulfate at 82° C. (180° F.). A pre-emulsion mixture was prepared using 437.7 g of distilled water, 16.04 g of lauryl alcohol sulfate emulsifier DISPONIL® SLS 2010 (BASF), 28.91 g of methacrylamide, 10.09 g of ethylene glycol dimethacrylate, 65.36 g of a 60% aqueous solution of N-methylol methacrylamide, 488.9 g of methyl methacrylate and 412.4 g of butyl acrylate. The pre-emulsion was delayed into the reactor over four hours at 80° C. (176° F.). When the pre-emulsion has finished, 43.6 g of distilled water was used to rinse the pre-emulsion tank. Five minutes later, the batch was cooled to 70° C. (158° F.) and 56.2 g of non-ionic emulsifier IGEPAL® CO-897 (Solvay) in 17.1 g of distilled water is added. This is followed by the simultaneous addition of 1.07 g of tertiary butyl hydroperoxide in 0.54 g of distilled water and 0.53 of sodium formaldehyde sulfoxylate in 21.02 g of distilled water. After 30 minutes, the batch is cooled to 35° C. (90° F.) and then stored in a labelled jar.

Preparation of the Pure Acrylic Polymer without any Crosslinker

A 3 L jacketed reactor was charged with 340.2 g of distilled water and 1.58 g of lauryl alcohol sulfate emulsifier DISPONIL® SLS 2010 (BASF). To this was added 3.51 g of distilled water and 0.16 g of ammonium persulfate at 82° C. (180° F.). A pre-emulsion mixture was prepared using 437.7 g of distilled water, 16.04 g of lauryl alcohol sulfate emulsifier DISPONIL® SLS 2010 (BASF), 28.91 g of methacrylamide, 10.09 g of ethylene glycol dimethacrylate, 488.9 g of methyl methacrylate and 412.4 g of butyl acrylate. The pre-emulsion was delayed into the reactor over four hours at 80° C. (176° F.). When the pre-emulsion has finished, 43.6 g of distilled water was used to rinse the pre-emulsion tank. Five minutes later, the batch was cooled to 70° C. (158° F.) and 56.2 g of non-ionic emulsifier IGEPAL® CO-897 (Solvay) in 17.1 g of distilled water is added. This is followed by the simultaneous addition of 1.07 g of tertiary butyl hydroperoxide in 0.54 g of distilled water and 0.53 of sodium formaldehyde sulfoxylate in 21.02 g of distilled water. After 30 minutes, the batch is cooled to 35° C. (90° F.) and then stored in a labelled jar.

Preparation of the Pure Acrylic with Acetoacetoxyethyl Methacrylate and Glycidyl Methacrylate (GMA)

A 3 L jacketed reactor was charged with 340.2 g of distilled water and 1.58 g of lauryl alcohol sulfate emulsifier DISPONIL® SLS 2010 (BASF). To this was added 3.51 g of distilled water and 0.16 g of ammonium persulfate at 82° C. (180° F.). A pre-emulsion mixture was prepared using 437.7 g of distilled water, 16.04 g of lauryl alcohol sulfate emulsifier DISPONIL® SLS 2010 (BASF), 28.91 g of methacrylamide, 10.09 g of ethylene glycol dimethacrylate, 72.5 g of acetacetoxyethyl methacrylate, 48.0 g of glycidyl methacrylate, 488.9 g of methyl methacrylate and 412.4 g of butyl acrylate. The pre-emulsion was delayed into the reactor over four hours at 80° C. (176° F.). When the pre-emulsion has finished, 43.6 g of distilled water was used to rinse the pre-emulsion tank. Five minutes later, the batch was cooled to 70° C. (158° F.) and 56.2 g of non-ionic emulsifier IGEPAL® CO-897 (Solvay) in 17.1 g of distilled water is added. This is followed by the simultaneous addition of 1.07 g of tertiary butyl hydroperoxide in 0.54 g of distilled water and 0.53 of sodium formaldehyde sulfoxylate in 21.02 g of distilled water. After 30 minutes, the batch is cooled to 35° C. (90° F.) and then stored in a labelled jar.

Preparation of the Pure Acrylic with Diacetone Acrylamide and Glycidyl Methacrylate (GMA)

A 3 L jacketed reactor was charged with 340.2 g of distilled water and 1.58 g of lauryl alcohol sulfate emulsifier DISPONIL® SLS 2010 (BASF). To this was added 3.51 g of distilled water and 0.16 g of ammonium persulfate at 82° C. (180° F.). A pre-emulsion mixture was prepared using 437.7 g of distilled water, 16.04 g of lauryl alcohol sulfate emulsifier DISPONIL® SLS 2010 (BASF), 28.91 g of methacrylamide, 10.09 g of ethylene glycol dimethacrylate, 39.2 g of diacetone acrylamide, 26 g of glycidyl methacrylate (GMA), 488.9 g of methyl methacrylate and 412.4 g of butyl acrylate. The pre-emulsion was delayed into the reactor over four hours at 80° C. (176° F.). When the pre-emulsion has finished, 43.6 g of distilled water was used to rinse the pre-emulsion tank. Five minutes later, the batch was cooled to 70° C. (158° F.) and 56.2 g of non-ionic emulsifier IGEPAL® CO-897 (Solvay) in 17.1 g of distilled water is added. This is followed by the simultaneous addition of 1.07 g of tertiary butyl hydroperoxide in 0.54 g of distilled water and 0.53 of sodium formaldehyde sulfoxylate in 21.02 g of distilled water. After 30 minutes, the batch is cooled to 35° C. (90° F.) and then stored in a labelled jar.

Preparation of the Pure Acrylic with Formyl Phenyl Methacrylate (FPMA) and Glycidyl Methacrylate (GMA)

A 3 L jacketed reactor was charged with 340.2 g of distilled water and 1.58 g of lauryl alcohol sulfate emulsifier DISPONIL® SLS 2010 (BASF). To this was added 3.51 g of distilled water and 0.16 g of ammonium persulfate at 82° C. (180° F.). A pre-emulsion mixture was prepared using 437.7 g of distilled water, 16.04 g of lauryl alcohol sulfate emulsifier DISPONIL® SLS 2010 (BASF), 28.91 g of methacrylamide, 10.09 g of ethylene glycol dimethacrylate, 27.9 g of formyl phenyl methacrylate (FPMA), 23.2 g of glycidyl methacrylate (GMA), 488.9 g of methyl methacrylate and 412.4 g of butyl acrylate. The pre-emulsion was delayed into the reactor over four hours at 80° C. (176° F.). When the pre-emulsion has finished, 43.6 g of distilled water was used to rinse the pre-emulsion tank. Five minutes later, the batch was cooled to 70° C. (158° F.) and 56.2 g of non-ionic emulsifier IGEPAL® CO-897 (Solvay) in 17.1 g of distilled water is added. This is followed by the simultaneous addition of 1.07 g of tertiary butyl hydroperoxide in 0.54 g of distilled water and 0.53 of sodium formaldehyde sulfoxylate in 21.02 g of distilled water. After 30 minutes, the batch is cooled to 35° C. (90° F.) and then stored in a labelled jar.

Preparation of the Styrene-Butadiene-Based Polymer without any Crosslinker

A jacketed 2-gallon reactor was charged with 1,952 g of deionized water (DI water), 16.4 g of sodium dodecyl branched diphenyl oxide anionic surfactant CALFAX® DB-45 (Pilot Chemical), 4 g of trisodium nitrilotriacetate chelating agent Hampene Na3 40%, 16 g of 100% itaconic acid, and 160.5 g of styrene. This mixture was agitated at 235 RPM and was heated to 66° C. (150° F.). Once at temperature, 192 g of 10% sodium persulfate and 96 g of DI water were charged to the vessel. The solution was mixed for 20 minutes before 28.4 g of sodium dodecyl branched diphenyl oxide anionic surfactant CALFAX® DB-45 (Pilot Chemical) and 96 g of DI water were added. Following the charge was a 10-minute mix before the temperature was increased to 71° C. (160° F.). The monomers were introduced in twelve separate charges in order to moderate the exotherm and maintain suitable reaction conditions within the vessel. Each charge contained 126 g of styrene, 0.8 g of tertiary dodecyl mercaptan (TDM), 32.3 g of acrylonitrile, and 80.3 g of butadiene. The timing between Monomer Charge 1 and Monomer Charge 12 was 470 minutes. 68 g of sodium dodecyl branched diphenyl oxide anionic surfactant CALFAX® DB-45 (Pilot Chemical) was added to the vessel between Monomer Charge 1 and Monomer Charge 6 in three separate charges. After Monomer Charge 6 the temperature was increased to 77° C. (170° F.). An additional charge of 96 g of 10% sodium persulfate was added after Monomer Charge 8, along with 96 g of DI water. 10.7 g of sodium dodecyl branched diphenyl oxide anionic surfactant CALFAX® DB-45 (Pilot Chemical) was added after Monomer Charge 10. After Monomer Charge 12 the batch was held for conversions for 180 minutes, before 4 g of non-ionic defoamer FOAM BLAST® 331E (Dystar) and 80 g of DI water were added to the vessel. This was mixed for 10 minutes before the batch was cooled to 38° C. (100° F.) and then stored in a labelled jar.

Preparation of the Styrene-Butadiene-Based Polymer with N-Methylolmethacrylamide

A jacketed 2-gallon reactor was charged with 1,952 g of deionized water (DI water), 16.4 g of sodium dodecyl branched diphenyl oxide anionic surfactant CALFAX® DB-45 (Pilot Chemical), 4 g of trisodium nitrilotriacetate chelating agent Hampene Na3 40%, 16 g of 100% itaconic acid, and 160.5 g of styrene. This mixture was agitated at 235 RPM and was heated to 66° C. (150° F.). Once at temperature, 192 g of 10% sodium persulfate and 96 g of DI water were charged to the vessel. The solution was mixed for 20 minutes before 28.4 g of sodium dodecyl branched diphenyl oxide anionic surfactant CALFAX® DB-45 (Pilot Chemical) and 96 g of DI water were added. Following the charge was a 10-minute mix before the temperature was increased to 71° C. (160° F.). The monomers were introduced in twelve separate charges in order to moderate the exotherm and maintain suitable reaction conditions within the vessel. Each charge contained 126 g of styrene, 0.8 g of tertiary dodecyl mercaptan (TDM), 32.3 g of acrylonitrile, and 80.3 g of butadiene. The timing between Monomer Charge 1 and Monomer Charge 12 was 470 minutes. In addition to the styrene, butadiene, TDM and acrylonitrile that was added in Monomer Charge 1, 58.7 g of 26% N-methylolmethacrylamide was charged in Monomer Charges 2 through 12. 68 g of sodium dodecyl branched diphenyl oxide anionic surfactant CALFAX® DB-45 (Pilot Chemical) was added to the vessel between Monomer Charge 1 and Monomer Charge 6 in three separate charges. After Monomer Charge 6 the temperature was increased to 77° C. (170° F.). An additional charge of 96 g of 10% sodium persulfate was added after Monomer Charge 8, along with 96 g of DI water. 10.7 g of sodium dodecyl branched diphenyl oxide anionic surfactant CALFAX® DB-45 (Pilot Chemical) was added after Monomer Charge 10. After Monomer Charge 12 the batch was held for conversions for 180 minutes, before 4 g of non-ionic defoamer FOAM BLAST® 331E (Dystar) and 80 g of DI water were added to the vessel. This was mixed for 10 minutes before the batch was cooled to 38° C. (100° F.) and then stored in a labelled jar.

Preparation of the Styrene-Butadiene-Based Polymer Containing 2,2-dimethoxyethyl Methacrylamide

A jacketed 2-gallon reactor was charged with 1,952 g of deionized water (DI water), 16.4 g of sodium dodecyl branched diphenyl oxide anionic surfactant CALFAX® DB-45 (Pilot Chemical), 4 g of trisodium nitrilotriacetate chelating agent Hampene Na3 40%, 16 g of 100% itaconic acid, and 160.5 g of styrene. This mixture was agitated at 235 RPM and was heated to 66° C. (150° F.). Once at temperature, 192 g of 10% sodium persulfate and 96 g of DI water were charged to the vessel. The solution was mixed for 20 minutes before 28.4 g of sodium dodecyl branched diphenyl oxide anionic surfactant CALFAX® DB-45 (Pilot Chemical) and 96 g of DI water were added. Following the charge was a 10-minute mix before the temperature was increased to 71° C. (160° F.). The monomers were introduced in twelve separate charges in order to moderate the exotherm and maintain suitable reaction conditions within the vessel. Each charge contained 126 g of styrene, 0.8 g of tertiary dodecyl mercaptan (TDM), 32.3 g of acrylonitrile, and 80.3 g of butadiene. The timing between Monomer Charge 1 and Monomer Charge 12 was 470 minutes. In addition to the styrene, butadiene, TDM and acrylonitrile that was added in Monomer Charge 1, 58.7 g of 26% 2,2-dimethoxyethyl methacrylamide was charged in Monomer Charges 2 through 12. 68 g of sodium dodecyl branched diphenyl oxide anionic surfactant CALFAX® DB-45 (Pilot Chemical) was added to the vessel between Monomer Charge 1 and Monomer Charge 6 in three separate charges. After Monomer Charge 6 the temperature was increased to 77° C. (170° F.). An additional charge of 96 g of 10% sodium persulfate was added after Monomer Charge 8, along with 96 g of DI water. 10.7 g of sodium dodecyl branched diphenyl oxide anionic surfactant CALFAX® DB-45 (Pilot Chemical) was added after Monomer Charge 10. After Monomer Charge 12 the batch was held for conversions for 180 minutes, before 4 g of non-ionic defoamer FOAM BLAST® 331E (Dystar) and 80 g of DI water were added to the vessel. This was mixed for 10 minutes before the batch was cooled to 38° C. (100° F.) and then stored in a labelled jar.

### Method of Preparing Coated Fabric

The carded polyester fiber was weighed and placed between two fiberglass screens for support. The weight was recorded and placed on top of the fiberglass screen. For Whatman, the paper was labeled and the tare weight recorded.

The latex solution was prepared at bath solids required for the desired binder content (or add-on %). The latex solution was poured into an aluminum pan.

The Lad Padder saturation machine was turned on. The pressure and speed were checked to confirm they were at 60 psi and 14.2 rpm, respectively.

The substrate (polyester fiber was sandwiched between the fiberglass screen (or Whatman paper) in the latex solution bath. The substrate was completely immersed.

The substrate was removed from the bath and the feed between the rollers. The coated substrate was pulled off the roller.

For polyester fiber: the sample was placed on the table. The top piece of wet fiberglass was removed and discarded. A dry piece of fiberglass was taken and placed on top of the sample. The entire sample was flipped over and the second piece of wet fiberglass was removed and also discarded. The sample was placed on the shelf to dry overnight.

For Whatman: the sample was placed on the shelf to dry or the paper was hung from the “clothesline” to dry. These samples can also be dried in an oven.

The sample was cured on a hot oil plate at 300° F. for 1 minute. After the sample was cured and allowed to cool, the final weight was recorded.

Method of Evaluating Time of Disintegration and/or Separation of Webs

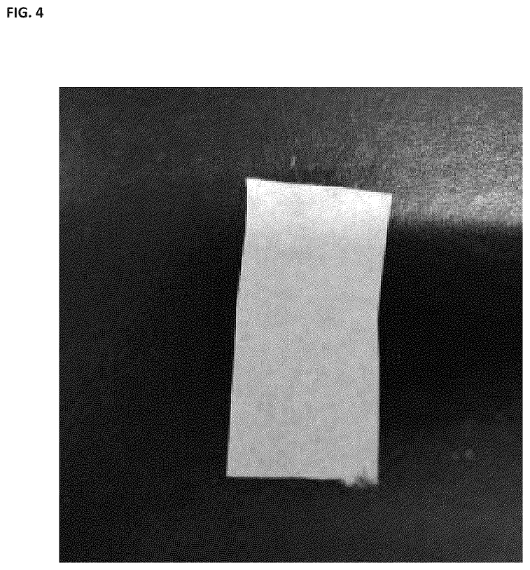

The coated fabric obtained from the Method of Preparing Coated Fabric section as described herein was then cut up into 6×3 cm² samples (see FIG. 4).

### Reaction Conditions—H₂O at High Temperature—Control

Into a flask with 100 g of distilled water was then placed a sample of the fabric which was bound with a polymer that was comprised of only standard backbone monomers (monomers which do not react with hydroxyl groups to form a cyclic structure that has only one carbon atom between two oxygen atoms other than the remainder of the ring atoms (i.e. an acetal as shown by the dioxolane below).

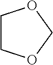

The flask contained a screw cap top which was then closed and the flask was clamped into a wrist shaker.

The flask was immersed by the wrist shaker into a water bath set at 50° C. (122° F.). The shaker was turned on to the highest degree of agitation and the sample was observed over time. The apparatus was covered with plastic to prevent the water from splashing over the benchtop and floor.

The temperature of the water bath was above the glass transition temperature (Tg—temperature at which a polymer begins to flow) of the latex so that the polymer can flow off of the fabric.

The fabric based on a polyester web did not disintegrate. Instead, the polyester web became a string after 1 hour due to the entanglements caused by the length of the fibers.

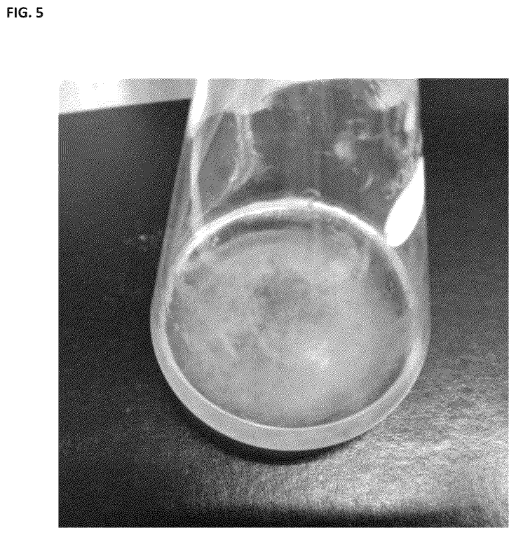

After seven hours, a fabric-based fluff pulp-based web had broken up into loose fibers (see FIG. 5).

### Reaction Conditions—High Temperature Acetic Acid Solution

The remaining samples were bound with a polymer containing a monomer which would react with hydroxyl groups (i.e., monomers which can react with hydroxyl groups to form a cyclic structure that has only one carbon atom between the two oxygen atoms other than the remainder of the ring atoms (i.e. an acetal such as the dioxolane ring below).

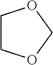

Such a monomer is typically referred to as a crosslinker, where it can react, for example, with a fabric bearing a hydroxyl group, a hydroxyl group on the same polymer chain or another polymer that contains hydroxyl groups.

The fluff pulp is typically unbonded cotton or separated wood fibers. Handsheets can be made from fluff pulp by the same process mentioned above.

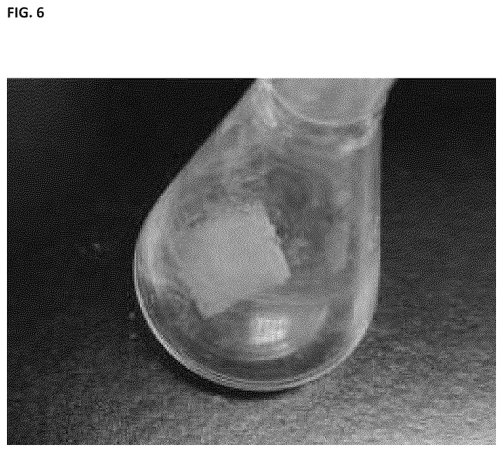

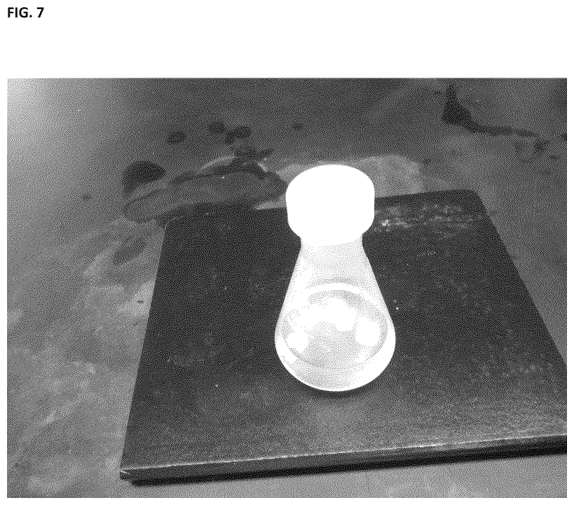

Method 1—The samples were similarly immersed into the respective flasks that contain a 50% aqueous acetic acid solution. The flasks themselves were clamped into the wrist shaker and then immersed into the 50° C. (122° F.) water bath and shaken at the highest degree of agitation possible (see FIG. 6 and FIG. 7). The amount of time it took for the web to disintegrate was recorded.

Method 2—The samples were immersed into a kettle that contains a >99.7% acetic acid solution. The solution was agitated at 215 RPM using a Teflon agitator and heated to 75° C. (167° F.). The amount of time it took for the fibers to separate from the web was recorded.

### Method for Tensile Testing

For dry tensile testing: The coated fabric obtained from the Method of Preparing Coated Fabric section as described herein was then cut using a cutting press and die into nine 5×1 inch sample specimens in the machine direction, and nine 5×1 inch sample specimens in the cross machine direction. Each specimen was then labeled with the sample identification and direction. On an Instron 5966, the Bluehill Universal software was loaded. The gauge length was set to a distance of 3 inches. The sample specimen was loaded into the Instron grips. The test was started and the sample specimen was pulled at a speed of 5 inches per minute until the sample specimen broke. The test was repeated until all eighteen samples were tested. The gram-force value and elongation for each sample specimen was then recorded.

For wet tensile testing: The coated fabric obtained from the Method of Preparing Coated Fabric section as described herein was then cut using a cutting press and die into nine 5×1 inch sample specimens in the machine direction, and nine 5×1 inch sample specimens in the cross machine direction. Each specimen was then labeled with the sample identification and direction. On an Instron 5966, the Bluehill Universal software was loaded. The gauge length was set to a distance of 3 inches. Each sample specimen was then folded in half such that the top and bottom were touching, and the center of the sample specimen was dipped into the wet tensile solution consisting of 0.5 wt % Aerosol OT in water. The sample specimen was loaded into the Instron grips. The test was started and the sample specimen was pulled at a speed of 5 inches per minute until the sample specimen broke. The test was repeated until all eighteen sample specimens were tested. The gram-force value and elongation for each sample specimen was then recorded.

Table 1 below shows that the vinyl acetate polymers do crosslink (as evidenced by the wet strength being greater than that provided by the polymer without a crosslinker) and that the polymer that contains conventional features (Comparative Example 4) does not disintegrate while those that use the crosslinkers as described herein do disintegrate in an aqueous acetic acid solution. Comparison of Comparative Example 1 versus Comparative Example 3 illustrates the observed variability in the process.

TABLE 1
Vinyl acetate homopolymer

| | | X-linking | Dry | Wet | Time to | | |
|---|---|---|---|---|---|---|---|
| | Monomer composition | monomer | Tensile | Tensile | Disintegrate | | Solution |
| Sample ID | (%) | (%) | (gf) | (gf) | Method 1 | | (%) |
| Comparative | Vinyl acetate (100) | none | 2471 | 578 | 6 | hours | 100% Water |
| Example 1 | | | | | | | |
| Comparative | Vinyl acetate (100) | none | 2471 | 578 | 20 | minutes | 50% aqueous |
| Example 2 | | | | | | | acetic acid |
| Comparative | Vinyl acetate (100) | none | 3168 | 448 | <45 | minutes | 50% aqueous |
| Example 3 | | | | | | | acetic acid |
| Comparative | Vinyl acetate (100) | 3% NMA | 2212 | 884 | >5 | days | 50% aqueous |
| Example 4 | | | | | | | acetic acid |
| Inventive | Vinyl acetate (100) | 2.9% DAAM / | 3430 | 843 | <45 | minutes | 50% aqueous |
| Example | | 2.4% GMA | | | | | acetic acid |
| Polymer 1 | | | | | | | |
| Inventive | Vinyl acetate (100) | 2.9% 2,2- | 4167 | 1158 | <45 | minutes | 50% aqueous |
| Example | | dimethoxyethyl | | | | | acetic acid |
| Polymer 2 | | methacrylamide | | | | | |

gf is a unit of force equivalent to 0.009807N

Table 2 below shows that the vinyl acrylic polymers do crosslink (evidenced by the wet strength being greater than that provided by the polymer without a crosslinker) and that the polymer that contains conventional features (Comparative Example 6) does not disintegrate while those that use the crosslinkers as described herein, do disintegrate in an aqueous acetic acid solution.

TABLE 2
Vinyl acrylic

| | | X-linking | Dry | Wet | Time to | | |
|---|---|---|---|---|---|---|---|
| | Monomer composition | monomer | Tensile | Tensile | Disintegrate | | Solution |
| Sample ID | (%) | (%) | (gf) | (gf) | Method 1 | | (%) |
| Comparative | Vinyl acetate (85%) | none | 2342 | 888 | 8 | hours | 100% Water |
| Example 5 | Butyl acrylate (15%) | | | | | | |
| Comparative | Vinyl acetate (81.8%) | 3% NMMA | 2960 | 1848 | >5 | days | 50% aqueous |
| Example 6 | Sutyl acrylate (15%) | | | | | | acetic acid |
| Inventive | Vinyl acetate (79.9%) | 2.9% DAAM / | 2411 | 1144 | <20 | hours | 50% aqueous |
| Example | Butyl acrylate (15%) | 2.0% GMA | | | | | acetic acid |
| Polymer 3 | | | | | | | |

gf is a unit of force equivalent to 0.009807N

Table 3 below shows that the polymers containing the features as described herein do crosslink (as evidenced by the wet strength being greater than that provided by the polymer without a crosslinker) and that the polymer that contains conventional features (Comparative Example 8) does not disintegrate while those that use the crosslinkers containing the features as described herein do disintegrate in an aqueous acetic acid solution.

TABLE 3
Pure acrylic

| | | X-linking | Dry | Wet | Time to | | |
|---|---|---|---|---|---|---|---|
| | Monomer composition | monomer | Tensile | Tensile | Disintegrate | | Solution |
| Sample ID | (%) | (%) | (gf) | (gf) | Method 1 | | (%) |
| Comparative | Methyl methacrylate | None | 3136 | 567 | <20 | hours | 100% Water |
| Example 7 | (49.9%) | | | | | | |
| | Butyl acrylate (42.1%) | | | | | | |
| Comparative | Methyl methacrylate | 4% NMA | 2155 | 1083 | >5 | days | 50% aqueous |
| Example 8 | (49.9%) | | | | | | acetic acid |
| | Butyl acrylate (42.1%) | | | | | | |
| Inventive | Methyl methacrylate | 7.4% AAEM/ | 2524 | 804 | <20 | hours | 50% aqueous |
| Example | (45.6%) | 4.9% GMA | | | | | acetic acid |
| Polymer 4 | Butyl acrylate (38.0%) | | | | | | |
| Inventive | Methyl methacrylate | 4% DAAM / | 2459 | 757 | <18 | hours | 50% aqueous |
| Example | (47.3%) | 2.65% GMA | | | | | acetic acid |
| Polymer 5 | Butyl acrylate (41.4%) | | | | | | |
| Inventive | Methyl methacrylate | 2.8% FPMA / | 2395 | 947 | 48 | hours | 50% aqueous |
| Example | (49.9%) | 2.4% GMA | | | | | acetic acid |
| Polymer 6 | Butyl acrylate (42.1%) | | | | | | |

gf is a unit of force equivalent to 0.009807N

Table 4 below shows that the polymers containing the features as described herein do crosslink (as evidenced by the wet strength being greater than that provided by the polymer without a crosslinker) and that the polymer that contains conventional features (Comparative Example 10) does not separate while those that use the crosslinkers containing the features as described herein do separate in an aqueous acetic acid solution.

TABLE 4
Styrene-butadiene

| | | X-linking | Dry | Wet | Time to | |
|---|---|---|---|---|---|---|
| | Monomer composition | monomer | Tensile | Tensile | Separate | Solution |
| Sample ID | (%) | (%) | (gf) | (gf) | Method 2 | (%) |
| Comparative | Styrene (52.8%) | None | 3182 | 821 | <24 hours | >99.7% glacial |
| Example 9 | Butadiene (33.7%) | | | | | acetic acid |
| | Acrylonitrile (13.5%) | | | | | |
| Comparative | Styrene (49.9%) | 7% NMA | 2992 | 1556 | >43 hours | >99.7% glacial |
| Example 10 | Butadiene (31.8%) | | | | | acetic acid |
| | Acrylonitrile (12.8%) | | | | | |
| Inventive | Styrene (49.9%) | 4.6% 2,2- | 3030 | 1491 | <43 hours | >99.7% glacial |
| Example | Butadiene (31.8%) | dimethoxyethyl | | | | acetic acid |
| Polymer 7 | Acrylonitrile (12.8%) | methacrylamide | | | | |

gf is a unit of force equivalent to 0.009807N

### Method for Preparing Wetlay Handsheets

Recycled pulp was blended with white water chemistry for 60 seconds. Virgin pulp was added and blended for an additional 30 seconds, followed by agitation in the headbox and draining, where the valve was closed as soon as the liquid was removed to lessen the amount of pulp going into the wire). The sample was transferred to a more closed wire by vacuum assist followed by transfer to a Teflon sheet for drying. The sample was dried in an oven for approximately 3 minutes at 130° C. and then rotated 180 degrees and dried for an additional 3 minutes at 130° C.

Tables 5 and 6 below show that the wet tensile strengths of the two handsheets are well within the standard deviations and are viewed as equivalent in that a handsheet comprised of 90% virgin fibers performs the same as one comprised of 90% virgin fibers and 10% recovered fibers.

TABLE 5

| | | | | | | | | | Normalized | |
|---|---|---|---|---|---|---|---|---|---|---|
| | | | Dry Tensile | | | | | | to 20% | Normalized |
| | | | | | % Tensile | | Tensile | | Binder | to 20% |
| | | | | | Strain | | Stress at | | Content | Binder |
| | Composition of | % Binder | Maximum | | at Max. | | Max. Load | | Maximum | Content |
| ID | Handsheet | Content | Load (gf) | S.D. | Load | S.D. | (gf/cm²) | S.D. | Load (gf) | S.D. |
| 1 | Unbonded Virgin Flulff | 0.0% | 43.3 | 4.1 | 1.4 | 0.3 | 19.9 | 4.7 | NA | NA |
| | Pulp handsheeet | | | | | | | | | |
| 2 | unbonded handsheet | 0.0% | 37.8 | 10.5 | 2.1 | 0.2 | −31.1 | 21.3 | NA | NA |
| | comprised of 90% | | | | | | | | | |
| | virgin fibers and 10% | | | | | | | | | |
| | recovered fibers | | | | | | | | | |
| 3 | Handsheet comprised | 24.72% | 5365.6 | 586.1 | 6.9 | 0.5 | 16877.6 | 15207.9 | 4341.1 | 474.2 |
| | of 100% virgin pulp | | | | | | | | | |
| | bound with a vinyl | | | | | | | | | |
| | acetate polymer | | | | | | | | | |
| | containing 2.9% | | | | | | | | | |
| | diacetone acrylamide | | | | | | | | | |
| | and 2.4% glycidyl | | | | | | | | | |
| | methacrylate | | | | | | | | | |
| 4 | Handsheet comprised | 21.23% | 3438.1 | 151.3 | 5.6 | 0.2 | 318.9 | 45.2 | 3238.9 | 142.5 |
| | of 90% virgin pulp and | | | | | | | | | |
| | 10% recovered fibers | | | | | | | | | |
| | bound with a vinyl | | | | | | | | | |
| | acetate polymer | | | | | | | | | |
| | containing 2.9% | | | | | | | | | |
| | diacetone acrylamide | | | | | | | | | |
| | and 2.4% glycidyl | | | | | | | | | |
| | methacrylate | | | | | | | | | |

TABLE 6

| | | | | | | | | | Normalized | |
|---|---|---|---|---|---|---|---|---|---|---|
| | | | Wet Tensile | | | | | | to 20% | Normalized |
| | | | | | % Tensile | | Tensile | | Binder | to 20% |
| | | | | | Strain | | Stress at | | Content | Binder |
| | Composition of | % Binder | Maximum | | at Max. | | Max. Load | | Maximum | Content |
| ID | Handsheet | Content | Load (gf) | S.D. | Load | S.D. | (gf/cm²) | S.D. | Load (gf) | S.D. |
| 1 | Unbonded Virgin Fluff | 0.0% | 17.7 | 4.3 | 3.3 | 0.5 | −14.7 | 10.3 | NA | NA |
| | Pulp handsheeet | | | | | | | | | |
| 2 | Unbonded handsheet | 0.0% | 23.6 | 6.2 | 4.8 | 1.3 | 26.8 | 29.3 | NA | NA |
| | comprised of 90% | | | | | | | | | |
| | virgin fibers and 10% | | | | | | | | | |
| | recovered fibers | | | | | | | | | |
| 3 | Handsheet comprised | 24.72% | 1482.0 | 364.2 | 10.7 | 1.4 | 292.3 | 17.3 | 1199.0 | 294.7 |
| | of 100% virgin pulp | | | | | | | | | |
| | bound with a vinyl | | | | | | | | | |
| | acetate polymer | | | | | | | | | |
| | containing 2.9% | | | | | | | | | |
| | diacetone acrylamide | | | | | | | | | |
| | and 2.4% glycidyl | | | | | | | | | |
| | methacrylate | | | | | | | | | |
| 4 | Handsheet comprised | 21.23% | 1172.7 | 191.0 | 9.4 | 0.3 | 307.7 | 41.4 | 1104.7 | 179.9 |
| | of 90% virgin pulp and | | | | | | | | | |
| | 10% recovered fibers | | | | | | | | | |
| | bound with a vinyl | | | | | | | | | |
| | acetate polymer | | | | | | | | | |
| | containing 2.9% | | | | | | | | | |
| | diacetone acrylamide | | | | | | | | | |
| | and 2.4% glycidyl | | | | | | | | | |
| | methacrylate | | | | | | | | | |

1. A method for separating a polymer-containing composition from a substrate coated with the composition, the method comprising:
contacting the coated substrate with an acidic solution under conditions sufficient to separate the composition from the substrate,
wherein at least one polymer present in the polymer-containing composition is formed from at least one monomer having one or more functional groups which form acid-labile covalent crosslinking bonds with the substrate and/or with itself and/or with a different polymer present in the polymer-containing composition.

2. The method according to claim 1, wherein the substrate is a fiber-containing substrate.

3. The method according to claim 1, wherein one or more surfaces of the substrate are partially or substantially coated with the polymer-containing composition.

4. The method according to claim 1, wherein the substrate is polyol-containing substrate.

5. The method according to claim 4, wherein the polyol-containing substrate contains cellulose.

6. The method according to claim 1, wherein the at least one polymer of the polymer-containing composition is crosslinked with the substrate.

7. The method according to claim 1, wherein the at least one polymer of the polymer-containing composition is crosslinked with a different polymer also present in the composition.

8. The method according to claim 1, wherein substantially all of the crosslinking between the substrate and the polymer-containing composition is acid labile.

9. The method according to claim 1, wherein the acid-labile covalent crosslinking bonds are acetal bonds or hemiacetal bonds or ketal bonds or hemiketal bonds or mixtures thereof.

10. The method according to claim 1, wherein the different polymer contains at least one hydroxy functional group or at least one polyol functional group.

11. The method according to claim 1, wherein the at least one polymer of the polymer-containing composition contains at least one aldehyde functional group or at least one ketone functional group.

12. The method according to claim 1, wherein the polymer-containing composition contains less than 0.05 wt % of formaldehyde relative to the total weight of the composition.

13. The method according to claim 1, wherein the acidic solution comprises water.

14. The method according to claim 1, wherein the acidic solution has a pH of greater than 4 and less than 7.

15. The method according to claim 1, wherein the acidic solution comprises acetic acid.

16. The method according to claim 1, wherein the polymer-containing composition is at least partially separated from the substrate after contact with the acidic solution.

17. The method according to claim 1, wherein the polymer-containing composition is substantially separated from the substrate after contact with the acidic solution.

18. The method according to claim 1, wherein the at least one monomer has the structure of Formula (1): 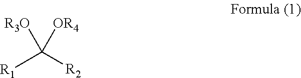
wherein:
R₁ contains an ethylenically unsaturated group;
R₂ is H, aliphatic, aryl, heteroaryl or heterocyclyl, where the aliphatic, aryl, heteroraryl and heterocyclyl moieties are unsubstituted or substituted;
R₃ is H, aliphatic, aryl, heteroaryl or heterocyclyl, where the aliphatic, aryl, heteroraryl and heterocyclyl moieties are unsubstituted or substituted; and
R₄ is H, aliphatic, aryl, heteroaryl or heterocyclyl, where the aliphatic, aryl, heteroraryl and heterocyclyl moieties are unsubstituted or substituted,
or R₃O and R₄O together with the carbon atom attached to R₃O and R₄O form a carbonyl (C═O).

19. Fibers recycled from a fiber-containing substrate coated with a polymer-containing composition by treatment of the fiber-containing substrate with an acidic solution having a pH of greater than 4 and less than 7.

20. Use of fibers separated from a substrate and from each other obtained by the method according to claim 2.

21. Use of a monomer as defined in claim 18 for forming acid labile covalent crosslinking bonds with a substrate.
